(19) United States
(12) Patent Application Publication
(10) Pub. No.: US 2008/0167842 A1
(43) Pub. Date: Jul. 10, 2008

(54) Method and system for detecting, analyzing and subsequently recognizing abnormal events

(75) Inventors: Edward L. Cochran, Minneapolis, MN (US); Wendy K. Foslien, Minneapolis, MN (US)

Correspondence Address: Kris T. Fredrick;Honeywell International Inc., 101 Columbia Rd., P.O. Box 2245, Morristown, NJ, 07962, US

(73) Assignee: Honeywell International Inc.

(21) Appl. No.: 11/649,987

(22) Filed: Jan. 4, 2007

(51) Int. Cl. G06F 17/18; G06F 11/07

(52) U.S. Cl. 703/2; 714/49; 714/E11.024

(57) ABSTRACT

A system and method for detecting and subsequently recognizing abnormal events. A variety of discrete process event data and continuous process data can be collected over an extended period and then incorporated into a principal component analysis (PCA). The PCA model describes the variability associated with characteristics of normal and abnormal operations. Information embedded in process alarms, operation actions and event journals can then be extracted in order to identify periods of normal and abnormal operations. Operator logs can be used to label each upset with a characteristic cause and/or recovery technique.

### TECHNICAL FIELD

Embodiments are generally related to data-processing systems and methods. Embodiments are also related to PCA (Principal Component Analysis) techniques. Embodiments are additionally related to statistical monitoring and alarm management methods and systems.

### BACKGROUND OF THE INVENTION

Abnormal situations commonly result from the failure of field devices such as instrumentation, control valves, and pumps or from some form of process disturbance that causes operations to deviate from a normal operating state. In particular, the undetected failure of key instrumentation and other devices, which are part of a process control system, can cause the control system to drive the process into an undesirable and dangerous state. Early detection of these failures enables an operation team to intervene before the control system escalates the failure into a more severe incident.

Statistical methods for detecting changes in industrial processes are included in a field generally known as statistical process control (SPC) or statistical quality control (SQC). The most widely used and popular SPC techniques involve univariate methods, that is, observing a single variable at a given time as well as statistics, such as mean and variance, that are derived from these variables. However, a univariate approach may well indeed work for monitoring a small number of process variables, and application to larger multivariable systems becomes difficult. This simplified approach to process monitoring requires an operator to continuously monitor perhaps dozens of different univariate charts, which substantially reduces the ability to make accurate assessments about the state of the process.

Multivariate statistical process control such as PCA (Principal Component Analysis has found wide application in process fault detection and diagnosis using existing measurement data. Process upsets in one part of an industrial and/or operating plant, for example, are multiplied by process interactions. Upsets and interactions directly affect bottom-line cost and quality. Finding the root cause of the upset is the key to stabilizing the plant, and achieving the highest levels of performance. When continuous industrial processes such as oil refining are disturbed, a wide variety of symptoms may arise, depending on their current operating parameters. Understanding the root cause of an upset, however, is difficult because of the variety of symptoms each upset can present.

In understanding how to address abnormal situations, it is important to understand the factors that cause or influence abnormal situations. An abnormal situation appears as a result of an interaction among multiple sources. For example, a frequent plant practice may be necessary to push a particular plant process to its limits in order to maximize production. Personnel are often requested to monitor and interact with such a process, which is typically complex and may be beyond the limits of their cognitive and physical response capabilities. At any point in the process, one or more of these factors may contribute to the onset and escalation of an abnormal state. The resulting abnormal situations vary in their complexity and effect continuous plant operational processes.

Based on the foregoing it is believed that a need exists for an improved technique for consistently detecting and subsequently recognizing abnormal events in operating plants. Additionally, a need exists for integrating the root cause of an upset in a structured manner in order to help operators of the process understand events that occur.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved data-processing system and method.

It is another aspect of the present invention to provide a technique for monitoring a process by employing principal component analysis.

It is a further aspect of the present invention to provide for an improved systems and methods for detecting and subsequently recognizing abnormal events in operating plants.

The aforementioned aspects and other objectives and advantages can now be achieved as described herein. A computer implemented system and method for detecting and subsequently recognizing abnormal events is disclosed. A variety of discrete process event data and continuous process data can be collected over an extended period and then incorporated into a principal component analysis (PCA) model. The PCA model describes the variabilities associated with characteristics of normal and abnormal operations. Information embedded in process alarms, operation actions and event journals can be extracted in order to identify periods of normal and abnormal operations by integration thereof in a structured manner. Operator logs can also be utilized to label each upset with a characteristic cause and/or recovery technique.

The output of PCA mode can be provided as a set of Eigen values that describe the variability in process space. The labeled state space can then be used in real time to determine whether the process is normal or abnormal. This addresses a key problem in developing multivariate statistical models for process monitoring. The information can be integrated in a structured manner, in order to take advantage of the knowledge embedded in the alarm system along with ensuring a human operator interaction with respect to the process.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a data-processing apparatus, which can be utilized to implement a preferred embodiment;

FIG. 2 illustrates a block diagram of a process control system, which can be implemented in accordance with a preferred embodiment;

FIG. 3 illustrates a high level flow chart of operations illustrating logical operational steps of a method for training of a PCA model, in accordance with an alternative embodiment;

FIG. 4 illustrates a high level flow chart of operations illustrating logical operational steps of a method for detecting, analyzing and subsequently recognizing abnormal events, in accordance with an alternative embodiment; and

FIG. 5 illustrates a high level flow chart of operations illustrating a method for running of PCA model during an online operation of a process, in accordance with an alternative embodiment.

### DETAILED DESCRIPTION

The particular values and configurations discussed in these non-limiting examples can be varied and are cited merely to illustrate at least one embodiment and are not intended to limit the scope thereof.

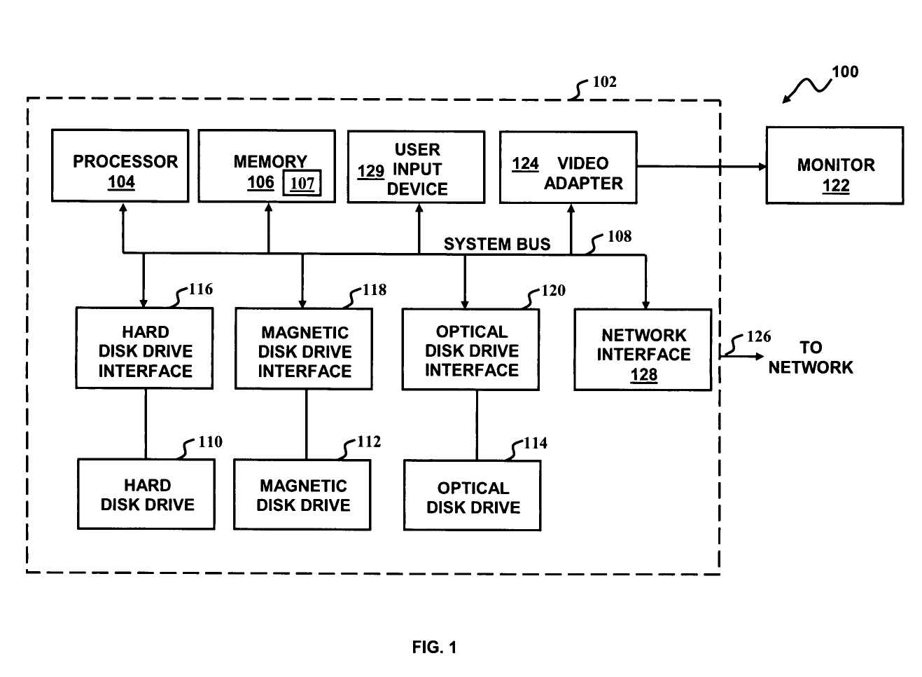

FIG. 1 illustrates a block diagram of a data-processing apparatus 100, which can be utilized to implement a preferred embodiment. Data-processing apparatus 100 can implement the present invention as described in greater detail herein. It can be appreciated that data-processing apparatus 100 represents merely one example of a system that can be utilized to implement the methods and systems described herein. Apparatus 100 is provided for general illustrative purposes only. Other types of data-processing systems can also be utilized to implement the present invention. Data-processing apparatus 100 can be configured to include a general purpose computing device 102. The computing device 102 generally includes a processing unit 104, a memory 106, and a system bus 108 that operatively couples the various system components to the processing unit 104. One or more processing units 104 operate as either a single central processing unit (CPU) or a parallel processing environment. A user input device 129 such as a mouse and/or keyboard can also be connected to system bus 108.

The data-processing apparatus 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium. A monitor 122 is connected to the system bus 108 through an adapter 124 or other interface. Additionally, the data-processing apparatus 100 can include other peripheral output devices (not shown), such as speakers and printers.

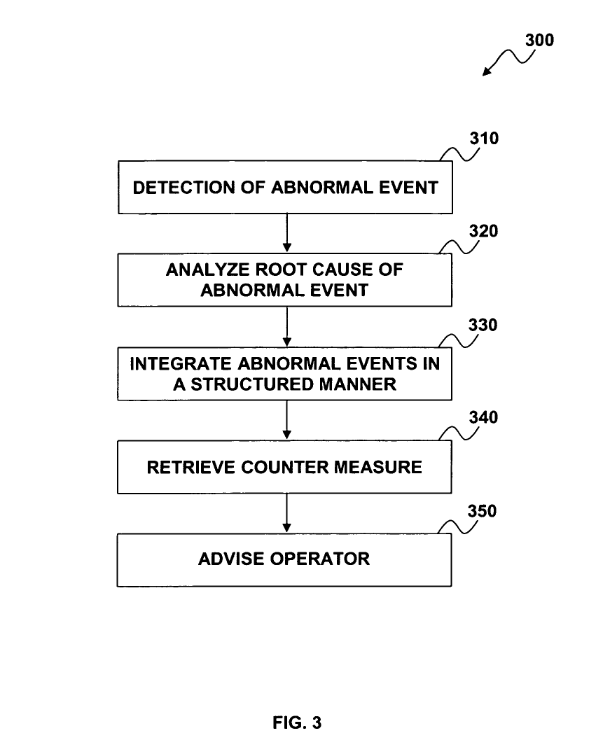

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the data-processing apparatus 100. Note that such computer-readable instructions, data structures, program modules, and other data can be implemented as a module 107. Module 107 can be utilized to implement the methods 300, 400 and 500 depicted and described herein with respect to FIGS. 3, 4 and 5. Module 107 and data-processing apparatus 100 can therefore be utilized in combination with one another to perform a variety of instructional steps, operations and methods, such as the methods described in greater detail herein.

Note that the embodiments disclosed herein can be implemented in the context of a host operating system and one or more module(s) 107. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 100, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the embodiments.

A number of program modules, such as, for example, module 107, can be stored or encoded in a machine readable medium such as the hard disk drive 110, the, magnetic disk drive 112, the optical disc drive 114, ROM, RAM, etc or an electrical signal such as an electronic data stream received through a communications channel. These program modules can include an operating system, one or more application programs, other program modules, and program data.

The data-processing apparatus 100 can operate in a networked environment using logical connections to one or more remote computers (not shown). These logical connections are implemented using a communication device coupled to or integral with the data-processing apparatus 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the data-processing apparatus 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means and communications devices for establishing a communications link between the computers can be used.

The method and system described herein relies on the use of PCA, which is employed to detect, analyze and subsequently recognize abnormal events in, for example, operating plants. Many process and equipment measurements can be gathered via digital process control devices deployed in a manufacturing system. Collected data can be “historized” in databases for analysis and reporting. Such databases can be mined for data patterns that occur during normal operations. The patterns can then be used to determine faults and when a process is behaving abnormally. The system uses data indicative of normal process behavior as training set data for monitoring how consistently time series data are synchronized with respect to the training set data. The method and system disclosed herein also uses Temporal PCA (T-PCA) techniques for monitoring the temporal behavior of a system and in particular temporal aspect of Early Event Detection (EED).

Fault detection for cases, where changes in variable values are not propagating on the technological equipment consistently with historical data (nominal model) is addressed. For example a feed increase is not propagated over the distillation column correctly, as the feed starts being accumulated in the column. Further a feed can be delayed in the distillation column too long (compared to the delays included in training set) where a Q statistic will get over the threshold. The same happens when the feed goes through the column too quickly. In another example temperature increase at the bottom of distillation column appears at the column top more quickly than in the historical data. The system monitors consistency of time dependent changes in the above mentioned process.

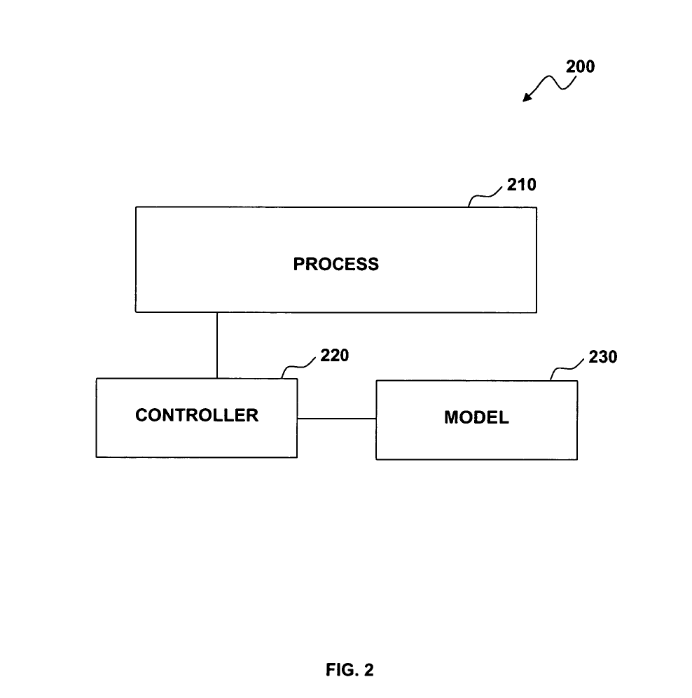

Referring to FIG. 2, a block diagram of a process control system 200 is illustrated, which can be implemented in accordance with a preferred embodiment. The process control system 200 generally includes a process 210 that is controlled by a controller 220 that in turn is coupled to the process 210 by hundreds, if not thousands of sensors, actuators, motor controllers, etc. Such sensors provide data representative of the state of the process 210 at desired points in time. A principal component analysis (PCA) model 230 is coupled to the controller 220, and receives the values of the sensors at predetermined times. Such times may occur at one-minute intervals for some processes, but may be varied, such as for processes that change more quickly or slowly with time.

PCA is a well known mathematical model that is designed to reduce the large dimensionality of a data space of observed variables to a smaller intrinsic dimensionality of feature space (e.g., latent variables), which are needed to describe the data economically. This is the case when there is a strong correlation between observed variables. The process 210 can include the use of discrete process event data such as, for example, process alarms or continuous process data (e.g., pressure, flow, temperature, etc). The output of PCA model 230 can be provided as a set of Eigen values that describe a variability in process 210. Such Eigen values can fully describe the variabilities that are characteristic of normal and abnormal operations, which in turn can be used to generate event signatures for different types of upsets related to process 210.

Referring to FIG. 3, a high level flow chart of operations of logical operational steps of method for detecting and analyzing abnormal events is illustrated, in accordance with an alternative embodiment. Note the process depicted in FIGS. 3, 4 and 5 can be implemented via a software module such as, for example, module 107 depicted in FIG. 1. As indicated at block 310 in FIG. 3, abnormal events can be detected. The root cause of the event can be analyzed, as illustrated thereafter at block 320. Next, as described at block 330, abnormal events can be integrated in a structured manner. As indicated thereafter at block 340, counter measures can be retrieved. The operator can then be advised of such counter measures, as depicted at block 350.

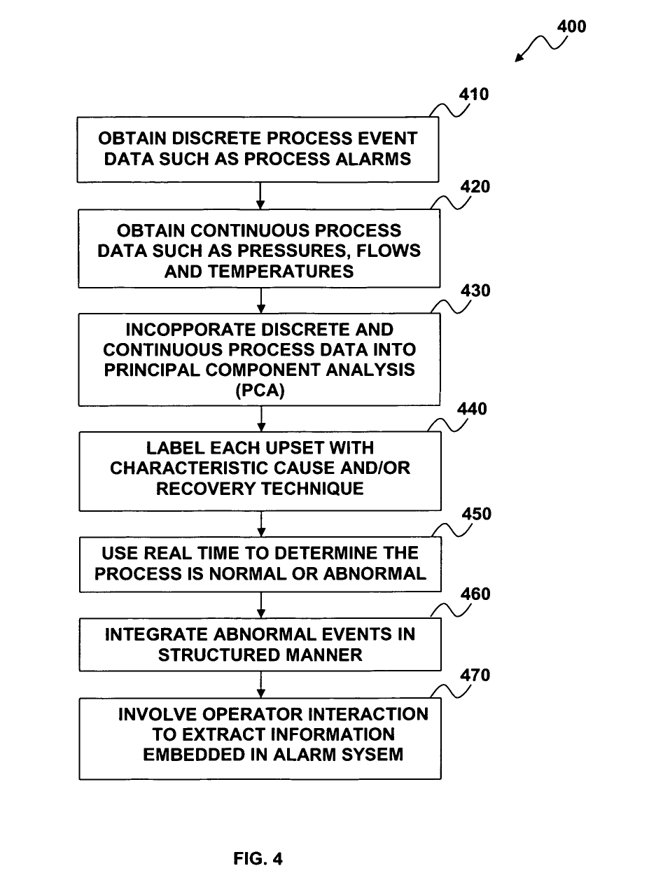

Referring to FIG. 4 a high level flow chart of operations of logical operational steps of a method 400 for detecting, analyzing and subsequently recognizing abnormal events is illustrated, in accordance with an alternative embodiment. Discrete process event data (e.g., process alarms) can be obtained, as depicted at block 410. Thereafter, as indicated at block 420, continuous process data such as pressure, flow, and temperature information can be obtained. The discrete and continuous process data can be incorporated into the PCA model 230, as shown at block 430. Next, as described at block 440, each upset can be labeled with a characteristic cause and/or recovery technique. Real-time data can be used to determine whether the process is normal or abnormal, as depicted at block 450. Next, abnormal events can be integrated in a structured manner, as illustrated at block 460. Thereafter, as indicated at block 470, operator interaction can be involved in order to extract information embedded in an alarm system.

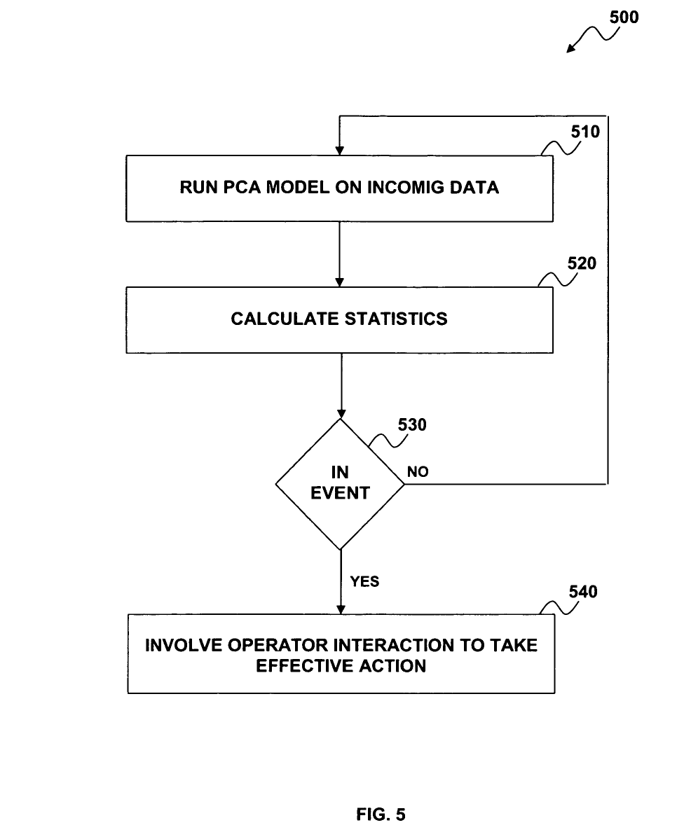

Referring to FIG. 5, a high-level flow chart of operations of a method 500 for processing a PCA model during the online operation of a process is illustrated, in accordance with an alternative embodiment. The PCA model 230 can receive real time data from the controller 220 as the process 210 is operating, as depicted in system 200 of FIG. 2. The PCA model 230 can then process incoming data, as illustrated at block 510. Thereafter, as depicted at block 520, statistics can be calculated. A test can be performed to determine if the process generates event signatures, as described at block 530. If an event is detected, operator interaction can be involved in order to take effective action, as shown at block 540. If, however, no other indicator of events is detected, the PCA model 230 will continue to run and process incoming data, as illustrated at block 510.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for detecting and subsequently recognizing abnormal events in a process, comprising:
obtaining a plurality of discrete process event data and a plurality of continuous process data corresponding to a process;
incorporating said plurality of discrete process event data and said plurality of continuous process data corresponding to said process into a principal component analysis model; and
utilizing real-time data in order to determine how said process corresponds to a plurality of abnormal events in order to detect and subsequently recognize said plurality of abnormal events in said process.

2. The method of claim 1 further comprising generating a plurality of signatures corresponding to said plurality of abnormal events.

3. The method of claim 1 integrating said plurality of abnormal events in a structured manner.

4. The method of claim 1 further comprising:
generating a plurality of signatures corresponding to said plurality of abnormal events; and
thereafter integrating said plurality of abnormal events in a structured manner.

5. The method of claim 1 further comprising analyzing said process utilizing said principal component analysis model.

6. The method of claim 1 further comprising calculating statistics related to said principal component analysis model.

7. The method of claim 1 further comprising:
determining if said plurality of abnormal event is occurring; and
thereafter facilitating an operator interaction in order to take an effective action with respect to said plurality of abnormal events and said process.

8. The method of claim 1 further comprising;
analyzing said process utilizing said principal component analysis model;
calculating statistics related to said principal component analysis model;
determining if said plurality of abnormal event is occurring; and
thereafter facilitating an operator interaction in order to take an effective action with respect to said plurality of abnormal events and said process.

9. A computer-implemented system for detecting and subsequently recognizing abnormal events in a process, said system comprising:
a data-processing apparatus;
a module executed by said data-processing apparatus, said module and said data-processing apparatus being operable in combination with one another to:
obtain a plurality of discrete process event data and a plurality of continuous process data corresponding to a process;
incorporate said plurality of discrete process event data and said plurality of continuous process data corresponding to said process into a principal component analysis model; and
utilize real-time data in order to determine how said process corresponds to a plurality of abnormal events in order to detect and subsequently recognize said plurality of abnormal events in said process.

10. The system of claim 9 wherein said module and said data-processing apparatus are further operable in combination with one another to generate a plurality of signatures corresponding to said plurality of abnormal events.

11. The system of claim 9 wherein said module and said data-processing apparatus are further operable in combination with one another to integrate said plurality of abnormal events in a structured manner.

12. The system of claim 9 wherein said module and said data-processing apparatus are further operable in combination with one another to:
generate a plurality of signatures corresponding to said plurality of abnormal events; and
thereafter integrate said plurality of abnormal events in a structured manner.

13. The system of claim 9 wherein said module and said data-processing apparatus are further operable in combination with one another to analyze said process utilizing said principal component analysis model.

14. The system of claim 9 wherein said module and said data-processing apparatus are further operable in combination with one another to calculate statistics related to said principal component analysis model.

15. The system of claim 9 wherein said module and said data-processing apparatus are further operable in combination with one another to:
determine if said plurality of abnormal event is occurring; and
thereafter facilitate an operator interaction in order to take an effective action with respect to said plurality of abnormal events and said process.

16. The method of claim 9 wherein said module and said data-processing apparatus are further operable in combination with one another to:
analyze said process utilizing said principal component analysis model;
calculate statistics related to said principal component analysis model;
determine if said plurality of abnormal event is occurring; and
thereafter facilitate an operator interaction in order to take an effective action with respect to said plurality of abnormal events and said process.

17. A computer-implemented system for detecting and subsequently recognizing abnormal events in a process, said system comprising:
a data-processing apparatus;
a module executed by said data-processing apparatus, said module and said data-processing apparatus being operable in combination with one another to:
obtain a plurality of discrete process event data and a plurality of continuous process data corresponding to a process;
incorporate said plurality of discrete process event data and said plurality of continuous process data corresponding to said process into a principal component analysis model;
utilize real-time data in order to determine how said process corresponds to a plurality of abnormal events; and
generate a plurality of signatures corresponding to said plurality of abnormal events in order to detect and subsequently recognize said plurality of abnormal events in said process.

18. The system of claim 17 wherein said module and said data-processing apparatus are further operable in combination with one another to thereafter integrate said plurality of abnormal events in a structured manner.

19. The system of claim 17 wherein said module and said data-processing apparatus are further operable in combination with one another to:
determine if said plurality of abnormal event is occurring; and
thereafter facilitate an operator interaction in order to take an effective action with respect to said plurality of abnormal events and said process.

20. The system of claim 17 wherein said module and said data-processing apparatus are further operable in combination with one another to:
analyze said process utilizing said principal component analysis model;
calculate statistics related to said principal component analysis model;
determine if said plurality of abnormal event is occurring; and
thereafter facilitate an operator interaction in order to take an effective action with respect to said plurality of abnormal events and said process.
